(19) United States
(12) Patent Application Publication
(10) Pub. No.: US 2026/0344620 A1
(43) Pub. Date: Nov. 5, 2026

(54) ACTUATOR AND PET TOY HAVING THE SAME

(71) Applicant: SHENZHEN CHEERBLE TECHNOLOGY CO., LTD., Shenzhen (CN)

(72) Inventors: Weicheng Guo, Shenzhen (CN); Jinbin Xie, Shenzhen (CN)

(21) Appl. No.: 19/724,460

(22) Filed: Jun. 29, 2026

(30) Foreign Application Priority Data
Sep. 12, 2025 (CN) 202521962164.2

(51) Int. Cl. A01K 15/02; F16H 1/20

(52) U.S. Cl. CPC A01K 15/025; F16H 1/20

(57) ABSTRACT

An actuator and a pet toy is disclosed in this application. The actuator is configured to be connected to a shell to form a pet toy having a shape of the shell. The actuator includes a housing. A drive assembly is mounted in the housing. A transmission shaft is mounted in the housing along a central axis of the housing. The transmission shaft is connected to the drive assembly and extends out of the housing. Opposite ends of the transmission shaft are each provided with a first connection portion, and the first connection portions are configured for transmission connection with the shell. One side of the housing is provided with a second.

### CROSS-REFERENCE TO RELATED APPLICATION(S)

The present application claims the benefit and priority to Chinese Patent Application No. 202521962164.2, filed on Sep. 12, 2025, in China National Intellectual Property Administration. The entire contents of which are incorporated herein by reference.

### FIELD

The subject matter relates to pet products, particularly to an actuator and a pet toy having the actuator.

### BACKGROUND

At present, with the rapid development of the pet economy, pet toys have gradually become essential daily products for pets. Mainstream electric or manual pet toys currently available on the market, whether driven by an internal motor or relying on a simple mechanical structure, generally have appearances and motion trajectories fixed by the manufacturing factories, and cannot be changed during use. For example, common rolling balls, cat teaser wands, and mouse cars only roll, swing, or move in a single direction, lacking sustained novelty to stimulate a pet's senses. Intelligent pets can quickly learn the pattern after a short period of playing the pet toys, which leads to a rapid decline in interest and leaves pet toys unused.

In addition, studies in pet behavior indicate that animals such as dogs and cats maintain attention for a longer period when the stimuli is unpredictable or can be explored in multiple ways. However, existing products fail to provide a dynamic structure that can be flexibly adjusted according to different scenarios or different growth stages of a pet. Therefore, changing fixed forms and single action modes of pet toys is needed.

### SUMMARY

The present disclosure provides an actuator applicable in a pet toy and a pet toy comprising the actuator, which can be flexibly configured into different forms to improve the interactive experience between pets and the toy.

An embodiment of an actuator according to the present disclosure includes a housing, a drive assembly disposed in the housing, a transmission shaft connected to the drive assembly, and a second connection portion disposed on one side of the housing. Opposite ends of the transmission shaft respectively extend out of the housing, and each of the opposite ends of the transmission shaft is provided with a first connection portion. An axial direction of the transmission shaft coincides with a central axis of the housing. Each of the first connection portions is configured to connect to and drive a corresponding one of shells. The second connection portion is disposed on a same side of the housing as one of the first connection portions, is configured to be fixedly connected to one of the shells, and a clearance gap is defined between the second connection portion and the one of the first connection portions located on the same side.

Another embodiment according to the present disclosure provides a pet toy including shells and the actuator described above. Each shell of the shells comprises either a fourth connection portion or a fifth connection portion on an inner surface thereof. The fourth connection portion is adapted to one of the first connection portions of the actuator, and the fifth connection portion is adapted to the second connection portion of the actuator. The actuator is configured to be detachably connected to two of the shells either through the first connection portions at the opposite ends of the transmission shaft cooperating with the fourth connection portion of each of the two shells, or through the second connection portion cooperating with the fifth connection portion of one of the shells and the first connection portion on a side opposite to the second connection portion cooperating with the fourth connection portion of another one of the shells.

Compared with conventional pet toys, the actuator and the pet toy of the present disclosure provide a dynamic structure that can be detachably assembled into different forms by selecting different combinations of the shells, thereby presenting different appearances and different motion states, and improving the user experience.

### BRIEF DESCRIPTION OF THE DRAWINGS

Implementations of the present technology will now be described, by way of example only, with reference to the attached figures, wherein:

FIG. 1 illustrates a structural schematic view of an actuator according to one embodiment of the present application.

FIG. 2 illustrates a structural schematic view of the actuator shown in FIG. 1, viewed from another perspective.

FIG. 3 illustrates an exploded view of the actuator shown in FIG. 1.

FIG. 4 illustrates a structural schematic view of a pet toy according to one embodiment of the present application.

FIG. 5 illustrates an exploded view of the pet toy shown in FIG. 4.

FIG. 6 illustrates an exploded view of the pet toy shown in FIG. 4, viewed from another perspective.

FIG. 7 illustrates a structural schematic view of a pet toy according to another embodiment of the present application.

FIG. 8 illustrates an exploded view of the pet toy shown in FIG. 7.

FIG. 9 illustrates a structural schematic view of a shell according to one embodiment of the present application.

FIG. 10 illustrates a structural schematic view of a weighted shell according to one embodiment of the present application.

FIG. 11 illustrates a sectional view taken along line A-A shown in FIG. 10.

FIG. 12 illustrates a structural schematic view of a pet toy according to one embodiment of the present application.

FIG. 13 illustrates a diagrammatic view of a pet toy according to one embodiment of the present application.

### DETAILED DESCRIPTION

The following detailed description is set forth to enable a person of ordinary skill in the art to make and use the invention. The description is provided in the context of specific applications and their requirements. Modifications to the disclosed embodiments will be apparent to those skilled in the art. The general principles defined herein may be applied to other embodiments without departing from the spirit and scope of the present invention.

The terms “first,” “second,” and similar ordinal terms are used solely to distinguish similar objects. They do not indicate any particular order or sequence. The term “exemplary” means serving as an example, instance, or illustration. Any embodiment described as exemplary is not to be construed as preferred or superior to other embodiments.

The terms “module” and “unit” refer to computer programs or portions thereof having predetermined functions. They cooperate with other parts to achieve a predetermined objective. They may be implemented in whole or in part using software, hardware, or a combination thereof. A single processor or multiple processors may implement one or more modules or units.

Unless otherwise defined, all technical and scientific terms used herein have the same meaning as commonly understood by persons of ordinary skill in the art. The terminology used herein is solely for the purpose of describing the embodiments and is not intended to limit the scope of the present application.

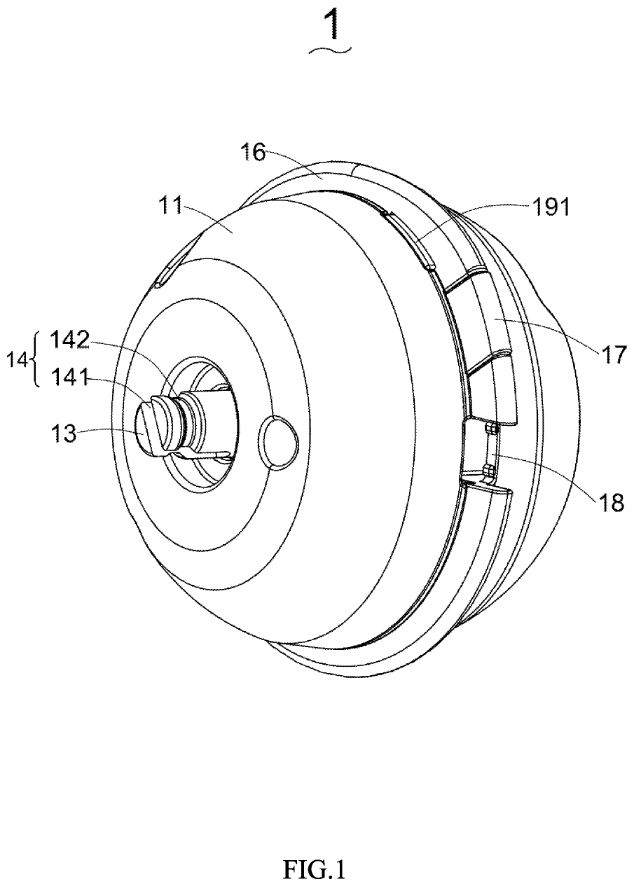

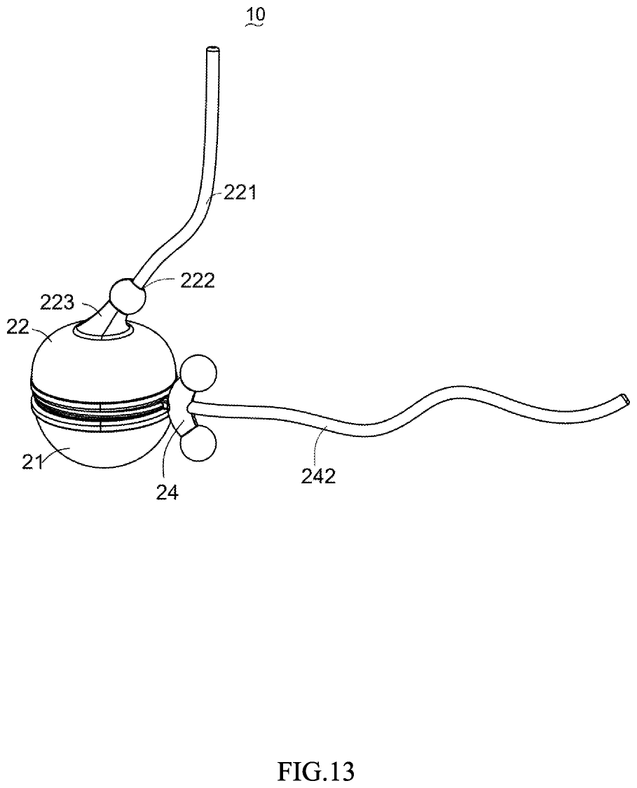

Referring to FIGS. 1, 4, 7, 12, and 13, an actuator 1 is provided according to an embodiment of the present application. The actuator 1 is detachably connected to different shells 2. By combining the actuator 1 with the shells 2 in different ways, pet toys 10 having different appearances and different motion states can be formed. This arrangement overcomes the limitation in the conventional art that “one toy equals one way to play.” This enables the pet toy 10 to present differentiated forms through combinations of different shells 2 with the same actuator 1, better adapting to a pet's exploratory nature, and maintaining the pet's interest in continuous playing with the pet toy 10.

Referring to FIGS. 1, 2, 6, and 8, in one embodiment of the present application, an actuator 1 is configured to be connected to shells 2 to form a pet toy 10 having a shape of the shells 2. The actuator 1 includes a housing 11, a drive assembly 12, and a transmission shaft 13. The drive assembly 12 is disposed in the housing 11. The transmission shaft 13 is connected to the drive assembly 12. An axial direction of the transmission shaft 13 coincides with a central axis of the housing 11. Opposite ends of the transmission shaft 13 respectively extend out of the housing 11. Each of the opposite ends of the transmission shaft 13 is provided with a first connection portion 14. Each first connection portion 14 is configured for a transmission connection with a corresponding one of the shells 2. A second connection portion 15 is disposed on one side of the housing 11. The second connection portion 15 is disposed on a same side of the housing 11 as one of the first connection portions 14 at one end of the transmission shaft 13. The second connection portion 15 is configured for a non-transmission connection with one of the shells 2. A clearance gap 111 is defined between the second connection portion 15 and the one of the first connection portions 14 located on the same side.

It should be understood that the actuator 1 can be detachably connected to different shells 2 through the first connection portions 14 at the opposite ends of the transmission shaft 13, or through the second connection portion 15 on one side of the housing 11 in cooperation with the first connection portion 14 on a side opposite to the second connection portion 15, so as to form pet toys 10 having different forms.

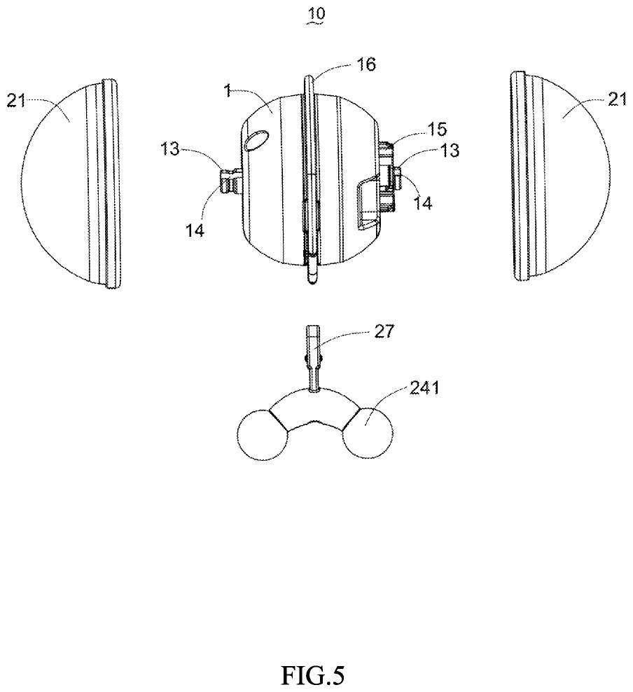

Specifically, compared with the conventional art, one side of the housing 11 is provided with both the first connection portion 14 and the second connection portion 15, and the other side of the housing 11 is provided with another first connection portion 14. When one shell 2 is connected to the first connection portion 14, the shell 2 can be driven by the transmission shaft 13. When one shell 2 is connected to the second connection portion 15, the shell 2 cannot be driven by the transmission shaft 13. Referring to FIG. 5, when the first connection portion 14 is connected to the shell 2, the second connection portion 15 on the same side does not affect the connection of the first connection portion 14 or the transmission of the transmission shaft 13 because of the clearance gap 111. When the second connection portion 15 is connected to the shell 2, the first connection portion 14 and the transmission shaft 13 on the same side are suspended within the shell 2 because of the clearance gap 111, and the shell 2 connected to the second connection portion 15 is not driven by the transmission shaft 13. In other words, the actuator 1 is provided on the same side with the first connection portion 14 for the transmission connection and the second connection portion 15 for the non-transmission connection, thereby supporting multiple assembly modes including dual-side driving and single-side driving. The clearance gap 111 is reserved between the second connection portion 15 and the first connection portion 14 located on the same side, thereby avoiding interference with the assembly of either of the first connection portion 14 and the second connection portion 15.

It should be understood that, in a first assembly mode, the actuator 1 is connected to two shells 2 through the first connection portions 14 at the opposite ends of the transmission shaft 13 extending out of the housing 11. The actuator 1 is wrapped by the two shells 2, thereby forming a pet toy 10 having the shape of the shells 2. The drive assembly 12 outputs power to the transmission shaft 13. The first connection portions 14 at the opposite ends of the transmission shaft 13 are respectively in transmission connection with the two shells 2. Power is thus transmitted to the two shells 2, so that the pet toy 10 presents a rolling or moving motion state to attract interactive play by a pet.

In a second assembly mode, the actuator 1 is connected to two shells 2 through the second connection portion 15 on one side of the housing 11 and the first connection portion 14 of the transmission shaft 13 on the other side of the housing 11. In other words, the actuator 1 is connected through the second connection portion 15 on one side of the housing 11 and the first connection portion 14 on a side opposite to the second connection portion 15. The actuator 1 is wrapped by the two shells 2, thereby forming a pet toy 10 having the shape of the shells 2. The drive assembly 12 outputs power to the transmission shaft 13. The first connection portion 14 at one end of the transmission shaft 13 is in transmission connection with one of the two shells 2, while the second connection portion 15 of the housing 11 is in non-transmission connection with the other of the two shells 2. Thus, power is transmitted to one of the two shells 2, while no power is transmitted to the other of the two shells 2. As a result, the pet toy 10 presents a single-side rotating motion state to attract interactive play by a pet. Through a single actuator 1 connected to different shells 2, the pet toy 10 can present different appearances and different motion states, thereby enriching ways of playing with the pet toy 10 and adapting to various scenarios for playing with pets.

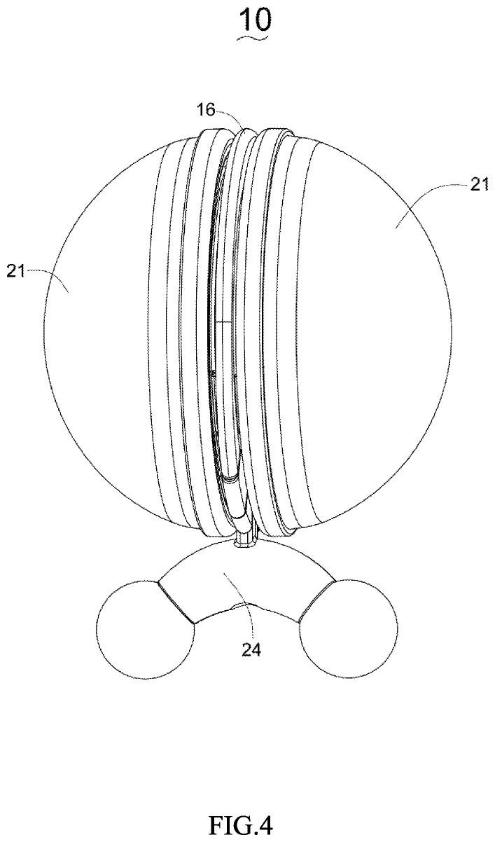

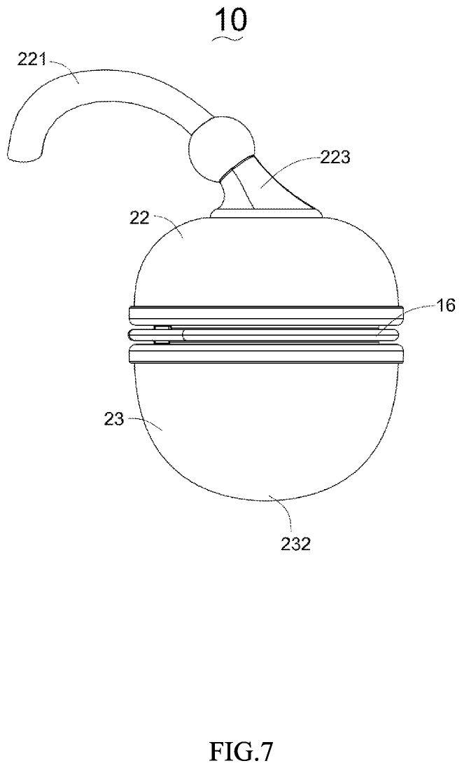

It should be understood that, referring to FIGS. 1, 2, and 3, opposite outer side surfaces of the housing 11 are provided with holes. The holes allow the transmission shaft 13 to pass through and extend out of the housing 11. Referring to FIGS. 4 and 7, when the actuator 1 is wrapped by two shells 2, the transmission shaft 13 is not exposed, thereby reducing a risk that pet hair may become entangled and jam the movement of the pet toy 10.

It should be understood that “transmission connection” refers to a connection mode capable of effectively transmitting torque or rotational speed of the transmission shaft 13 to the shell 2 during operation of the pet toy 10. “Non-transmission connection” refers to a connection mode in which the shell 2 is not driven by the transmission shaft 13 and does not bear the output torque of the transmission shaft 13 during the assembly and normal operation of the pet toy 10. The “clearance gap 111” refers to a space located between the first connection portion 14 and the second connection portion 15 on the same side and configured to avoid interference with the assembly and operation of the pet toy 10.

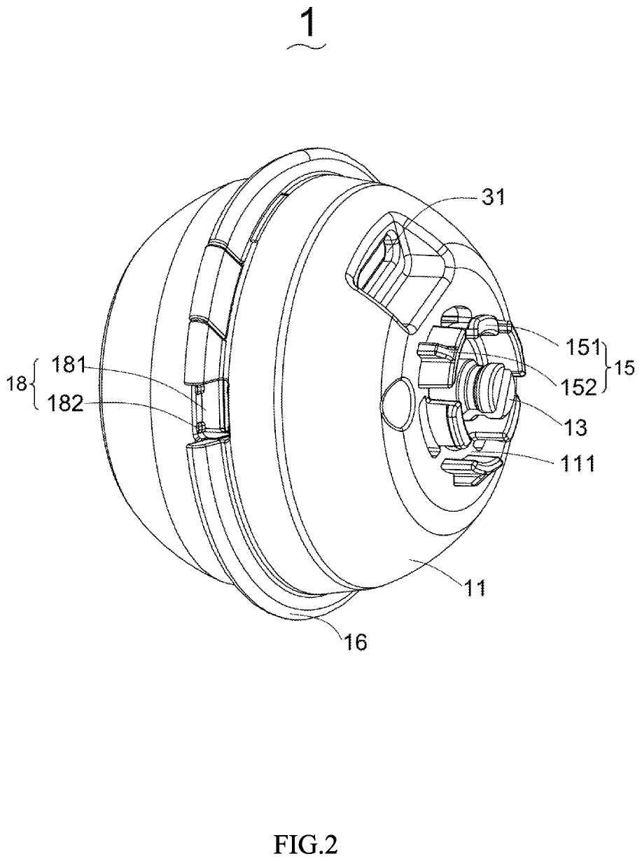

Referring to FIGS. 1 and 2, in at least one embodiment of the present application, the first connection portion 14 includes an anti-rotation portion 141 and a positioning portion 142. The anti-rotation portion 141 is disposed along the axial direction of the transmission shaft 13. The positioning portion 142 is disposed along a circumferential direction of the transmission shaft 13.

Specifically, the anti-rotation portion 141 disposed along the axial direction of the transmission shaft 13 can axially engage with the shell 2 to restrict relative circumferential movement of the shell 2. The positioning portion 142 disposed along the circumferential direction of the transmission shaft 13 can circumferentially engage with the shell 2 to restrict relative axial movement of the shell 2. In this way, through the first connection portions 14 at the two ends of the transmission shaft 13, the shell 2 is relatively fixed at the two ends of the transmission shaft 13, such that the transmission shaft 13 drives the movement of the shell 2, thereby enabling the pet toy 10 to roll or move.

Referring to FIGS. 2 and 5, in at least one embodiment of the present application, the second connection portion 15 includes a snap-fit portion 151 and a guide portion 152. The snap-fit portion 151 and the guide portion 152 are disposed on an outer surface of the housing 11 and are spaced apart around the transmission shaft 13.

Specifically, the guide portion 152 can guide the shell 2 toward the snap-fit portion 151, and the snap-fit portion 151 can snap-connect with the shell 2. In this manner, the shell 2 is snap-connected to the second connection portion 15 and relatively fixed to the second connection portion 15. The second connection portion 15 on one side of the housing 11 is snap-connected to one shell 2, and the first connection portion 14 on the other side of the housing 11 is in transmission connection with another shell 2; that is, the first connection portion 14 on a side opposite to the second connection portion 15 is in transmission connection with the other shell 2. Thus, one shell 2 is relatively fixed to the actuator 1 on one side, while the shell 2 on the other side is driven by the movement of the transmission shaft 13, thereby enabling the pet toy 10 to perform a single-side rotating movement.

It should be understood that the snap-fit portion 151 and the guide portion 152 are arranged around the transmission shaft 13 at intervals, and a length of the second connection portion 15 is less than a length of the transmission shaft 13 extending out of the housing 11. Thus, the clearance gap 111 is reserved between the second connection portion 15 and the first connection portion 14 on the same side, so that different shells 2 can be replaced through different connection portions of the actuator 1 without affecting the assembly of the different connection portions, thereby enabling different appearances and different motion states of the pet toy 10.

Referring to FIG. 1, in at least one embodiment of the present application, the housing 11 is provided with a protruding portion 16. The protruding portion 16 protrudes at least partially around an outer circumference of the housing 11. The housing 11 is further provided with a button 17. The button 17 is adjacent to the protruding portion 16 and protrudes along the outer circumference of the housing 11.

Specifically, the protruding portion 16 may protrude around an entire circumference of an outer surface of the housing 11, or may protrude locally around only part of the outer circumference of the housing 11. A user can conveniently connect the actuator 1 with the shell 2 through the protruding portion 16. For example, when the shell 2 is to be detached from the actuator 1, a point of force application can be found at the protruding portion 16, making removal easier and more convenient. At the same time, the protruding portion 16 can prevent an edge of the shell 2 from being damaged during assembly, thereby ensuring the stability and reliability of the connection between the actuator 1 and the shell 2.

It should be understood that, referring to FIGS. 4, 7, 12, and 13, the shell 2 wraps around the actuator 1, but the protruding portion 16 is not wrapped by the shell 2. An edge of the protruding portion 16 is lower than an edge of the shell 2, so that movement of the shell 2 is not hindered. The button 17 is connected to the drive assembly 12. The button 17 is adjacent to the protruding portion 16 and protrudes along the outer circumference of the housing 11. Therefore, the button 17 is also not wrapped by the shell 2, allowing a user to actuate the button 17 without removing the shell 2, so that the pet toy 10 can be started, stopped, or switched between functions.

Referring to FIGS. 1 and 2, in at least one embodiment, the housing 11 is provided with the protruding portion 16, and the protruding portion 16 protrudes at least partially around an outer circumference of the housing 11. The housing 11 is further provided with a third connection portion 18. The third connection portion 18 is adjacent to the protruding portion 16 and is disposed on an outer surface of the housing 11.

It should be understood that the third connection portion 18 is disposed on the outer surface of the housing 11 adjacent to the protruding portion 16 and is therefore not wrapped by the shell 2. A user can therefore assemble and disassemble a support member 24 on the pet toy 10 without removing the shell 2, thereby adding another shape and another motion state to the pet toy 10.

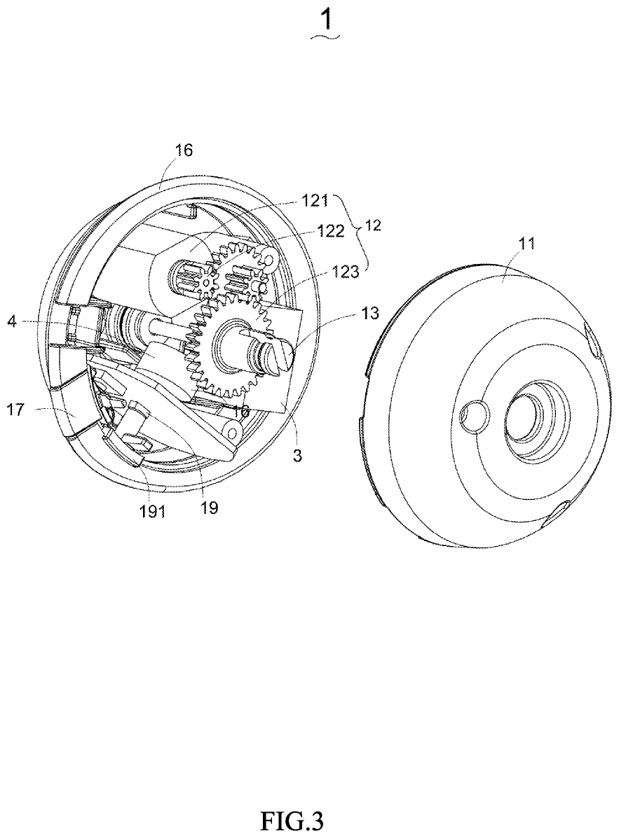

Referring to FIGS. 1 and 3, in at least one embodiment, the housing 11 is provided with the protruding portion 16, and the protruding portion 16 protrudes at least partially around an outer circumference of the housing 11. A light-emitting unit 19 is mounted within the housing 11. The light-emitting unit 19 is arranged to emit light toward the protruding portion 16.

It should be understood that the light-emitting unit 19 is arranged to emit light toward the protruding portion 16, so that the light emitted by the light-emitting unit 19 is not blocked by the shell 2. A hole or a transparent member 191 may be provided at the protruding portion 16 so that the light-emitting unit 19 can emit light through the hole or through the transparent member 191.

In at least one embodiment, the housing 11 is provided with the protruding portion 16, and the protruding portion 16 protrudes partially around an outer circumference of the housing 11. The housing 11 is provided with the button 17, the button 17 being adjacent to the protruding portion 16 and protruding along the outer circumference of the housing 11. The housing 11 is further provided with the third connection portion 18, the third connection portion 18 being adjacent to the protruding portion 16 and disposed on an outer surface of the housing 11. The light-emitting unit 19 is mounted within the housing 11 and is arranged to emit light toward the protruding portion 16.

Specifically, referring to FIGS. 1, 2, and 3, the light-emitting unit 19, the button 17, and the third connection portion 18 may be arranged adjacent to the protruding portion 16 in sequence. The button 17 is disposed adjacent to the third connection portion 18. When the support member 24 is connected to the third connection portion 18, this arrangement can ensure that the button 17 is not accidentally touched during the movement of the pet toy 10. The light-emitting unit 19 is disposed adjacent to the button 17 so that a light color can be more easily distinguished and a current function mode of the actuator 1 can be recognized. It should be understood that the protruding portion 16 may protrude around an entire circumference of the outer surface of the housing 11. However, according to functional and play requirements of the pet toy 10, positions for the button 17, the third connection portion 18, and the light-emitting unit 19 may be reserved in the protruding portion 16 extending around the outer surface of the housing 11.

Referring to FIG. 2, in at least one embodiment of the present application, the third connection portion 18 includes an insertion portion 181 and a limiting portion 182. The insertion portion 181 is disposed on the outer surface of the housing 11. The limiting portion 182 is located at an edge of the insertion portion 181.

Specifically, the insertion portion 181 allows the support member 24 to be easily positioned and connected. The limiting portion 182 limits the movement of the support member 24 so that the support member 24 is relatively fixed on the actuator 1. When the actuator 1 is to be assembled with the shell 2 and further connected to the support member 24 through the third connection portion 18, another form of the pet toy 10 is provided, thereby giving a pet another play experience. More specifically, a depth of the insertion portion 181 extends in a radial direction of the housing 11, thereby facilitating insertion between the third connection portion 18 and the support member 24.

Referring to FIG. 3, in at least one embodiment of the present application, the drive assembly 12 includes a motor 121, an input gear 122, and an output gear 123. The input gear 122 is mounted on an output end of the motor 121. The output gear 123 is connected to the transmission shaft 13. The input gear 122 meshes with the output gear 123.

Specifically, the output end of the motor 121 drives the input gear 122 to rotate. Through the meshing engagement between the input gear 122 and the output gear 123, the output gear 123 transmits power to the transmission shaft 13. This arrangement enables accurate and stable power transmission.

It should be understood that, to optimize the drive efficiency of the actuator 1, the actuator 1 may be configured with a gearbox assembly including multiple gears. The gearbox assembly also includes the input gear 122 and the output gear 123. The input gear 122 transmits power to the output gear 123 through meshing engagement of the multiple gears. The output end of the motor 121 is connected to the input gear 122, and the output gear 123 is connected to the transmission shaft 13. In other words, power output from the motor 121 is transmitted to the transmission shaft 13 through the gearbox assembly, so that a movement speed and force of the transmission shaft 13 can be precisely controlled, allowing the assembled pet toy 10 to present a more stable motion state.

Referring to FIG. 3, in at least one embodiment, the housing 11 is configured to receive a power supply member 3 disposed in the housing 11. The power supply member 3 is connected to the drive assembly 12 and is configured to supply power to the drive assembly 12. Preferably, the actuator 1 further includes a charging port 31. The charging port 31 is disposed on an outer surface of the housing 11 and is electrically connected to the power supply member 3, and is thereby configured to connect the power supply member 3 to the drive assembly 12 through the power supply member 3, so that a user can conveniently charge the power supply member 3 through the charging port 31, thereby reducing the need to remove and replace the power supply member 3.

Referring to FIG. 3, in at least one embodiment, the actuator 1 further includes a sound-generating unit 4 disposed in the housing 11. The sound-generating unit 4 emits sound to attract a pet to approach the pet toy 10 for interactive play. The sound-generating unit 4 may be a buzzer, a speaker, or another sound-generating component.

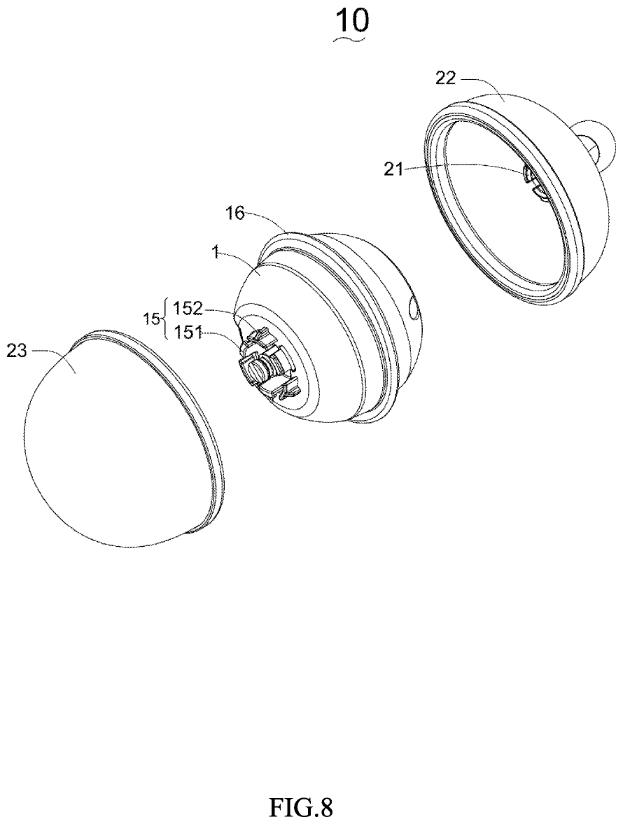

Referring to FIGS. 5 and 8, an embodiment of the present application provides a pet toy 10 including shells 2 and the actuator 1 described above. Inner surfaces of the shells 2 include a fourth connection portion 25 or a fifth connection portion 26. In one arrangement, inner surfaces of two shells 2 each include the fourth connection portion 25, each fourth connection portion 25 is adapted to a respective one of the first connection portions 14, and the actuator 1 is detachably connected to the two shells 2 through the first connection portions 14 at the two ends of the transmission shaft 13 and the fourth connection portions 25 of the two shells 2, so as to form the pet toy 10 having the shape of the shells 2. Alternatively, an inner surface of a first shell 2 includes the fourth connection portion 25, and an inner surface of a second shell 2 includes the fifth connection portion 26; the fourth connection portion 25 is adapted to one of the first connection portions 14, and the fifth connection portion 26 is adapted to the second connection portion 15; and the actuator 1 is detachably connected to the first shell 2 and the second shell 2 through the second connection portion 15 on one side of the housing 11 cooperating with the fifth connection portion 26, and through the first connection portion 14 on a side opposite to the second connection portion 15 cooperating with the fourth connection portion 25, so as to form the pet toy 10 having the shape of the shells 2.

It should be understood that the fourth connection portion 25 on an inner surface of the shell 2 is adapted to the first connection portion 14 of the actuator 1, or the fifth connection portion 26 on an inner surface of the shell 2 is adapted to the second connection portion 15 of the actuator 1. Thus, the first connection portions 14 at the two ends of the transmission shaft 13 of the actuator 1 can be detachably connected with two shells 2 each including the fourth connection portion 25, so that the two shells 2 cover opposite sides of the actuator 1 and form a pet toy 10 shaped by the shells 2 and having dual-side driving. Alternatively, the second connection portion 15 on one side of the actuator 1 can be detachably connected with one shell 2 including the fifth connection portion 26, and the first connection portion 14 on the other side of the actuator 1 can be detachably connected with another shell 2 including the fourth connection portion 25, so that the two shells 2 cover opposite sides of the actuator 1 and form a pet toy 10 shaped by the shells 2 and having single-side driving. By connecting a single actuator 1 with two shells 2 in different ways, the pet toy 10 can present different appearances and different motion states, thereby overcoming the limitation in the prior art that “one toy equals one way to play,” and allowing the pet toy 10 to produce differentiated motion forms through different combinations of the shells 2, so as to attract pets at different growth stages and satisfy play needs of pets.

Referring to FIGS. 4, 5, 6, and 9, in at least one embodiment of the present application, at least one of the shells 2 is a roller shell 21. The roller shell 21 is hollow and hemispherical. An inner surface of the roller shell 21 includes the fourth connection portion 25. The fourth connection portion 25 includes a shaft groove 251, an anti-rotation mating portion 252, and a positioning mating portion 253. The anti-rotation mating portion 252 is distributed axially along an inner wall of the shaft groove 251. The positioning mating portion 253 is distributed circumferentially along the inner wall of the shaft groove 251.

Referring to FIGS. 7, 8, and 9, in at least one embodiment of the present application, at least one of the shells 2 is a rope-swing shell 22. An outer surface of the rope-swing shell 22 is configured to connect to a first rope member 221. An inner surface of the rope-swing shell 22 includes the fourth connection portion 25. The fourth connection portion 25 includes the shaft groove 251, the anti-rotation mating portion 252, and the positioning mating portion 253. The anti-rotation mating portion 252 is distributed axially along the inner wall of the shaft groove 251. The positioning mating portion 253 is distributed circumferentially along the inner wall of the shaft groove 251.

Referring to FIGS. 7, 8, 10, and 11, in at least one embodiment of the present application, at least one of the shells 2 is a weighted shell 23. A weight block 231 is mounted in the weighted shell 23. A curved surface 232 is provided at a center of an outer surface of the weighted shell 23. The weight block 231 is disposed adjacent to the curved surface 232. An inner surface of the weighted shell 23 includes the fifth connection portion 26. The fifth connection portion 26 includes a snap-fit mating portion 261 and a guide mating portion 262. The snap-fit mating portion 261 and the guide mating portion 262 are spaced apart around a central axis of the weighted shell 23.

It should be understood that, when the fourth connection portion 25 on the inner surface of the roller shell 21 is connected to the first connection portion 14 of the actuator 1, the shaft groove 251 facilitates alignment of the transmission shaft 13. First, the anti-rotation mating portion 252 distributed axially along the inner wall of the shaft groove 251 engages with the anti-rotation portion 141 disposed along the axial direction of the transmission shaft 13, thereby restricting relative circumferential movement between the roller shell 21 and the actuator 1. Then, the positioning mating portion 253 distributed circumferentially along the inner wall of the shaft groove 251 engages with the positioning portion 142 disposed along the circumferential direction of the transmission shaft 13, thereby restricting relative axial movement between the roller shell 21 and the actuator 1. In this way, the roller shell 21 is relatively fixed on one side of the actuator 1. The fourth connection portions 25 of two roller shells 21 are mounted on the first connection portions 14 at the opposite ends of the transmission shaft 13, so that the two roller shells 21 are relatively fixed on opposite sides of the actuator 1. Thus, power transmitted by the drive assembly 12 to the transmission shaft 13 drives the roller shells 21, so that the pet toy 10 presents a rolling or moving motion state. It should further be understood that the roller shell 21 is hollow and hemispherical and can wrap the actuator 1 well. Because a single roller shell 21 is hemispherical, two roller shells 21 together form a sphere. When the transmission shaft 13 transmits power to the roller shells 21, the spherical shape more readily rolls randomly and is therefore better suited to a pet's exploratory nature.

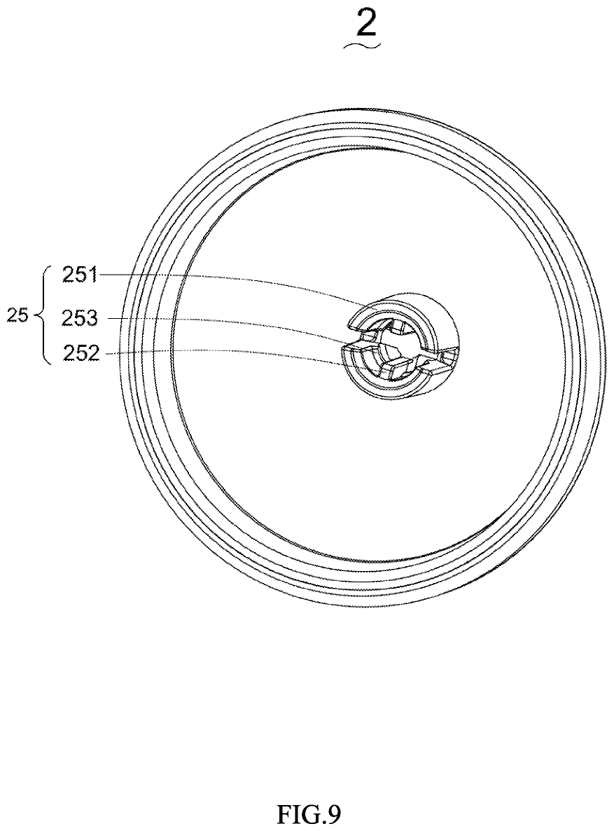

Preferably, referring to FIG. 1, the positioning portion 142 is disposed at an end of the transmission shaft 13 away from the housing 11. Referring to FIG. 9, the positioning mating portion 253 is disposed adjacent to a groove bottom of the shaft groove 251. When the anti-rotation mating portion 252 of the roller shell 21 moves axially along the anti-rotation portion 141, the transmission shaft 13 can be inserted into the roller shell 21 as much as possible until the positioning portion 142 away from the housing 11 snap-engages with the positioning mating portion 253 adjacent to the groove bottom, so that the roller shell 21 is relatively fixed on one side of the transmission shaft 13.

It should be understood that, when the fifth connection portion 26 on the inner surface of the weighted shell 23 is connected to the second connection portion 15 on one side of the actuator 1, the snap-fit mating portion 261 and the guide mating portion 262 of the fifth connection portion 26 are spaced apart around the central axis of the weighted shell 23, and the snap-fit portion 151 and the guide portion 152 of the second connection portion 15 are spaced apart around the transmission shaft 13. Therefore, through the matching between the guide portion 152 and the guide mating portion 262, the snap-fit portion 151 is guided toward the snap-fit mating portion 261 for snap connection, so that the weighted shell 23 is relatively fixed on one side of the actuator 1. On the other side of the actuator 1, the first connection portion 14 is connected to the fourth connection portion 25 on the inner surface of the rope-swing shell 22. The shaft groove 251 facilitates alignment of the transmission shaft 13. First, the anti-rotation mating portion 252 distributed axially along the inner wall of the shaft groove 251 engages with the anti-rotation portion 141 disposed along the axial direction of the transmission shaft 13, thereby restricting relative circumferential movement between the rope-swing shell 22 and the actuator 1. Then, the positioning mating portion 253 distributed circumferentially along the inner wall of the shaft groove 251 engages with the positioning portion 142 disposed along the circumferential direction of the transmission shaft 13, thereby restricting relative axial movement between the rope-swing shell 22 and the actuator 1. In this way, the rope-swing shell 22 is relatively fixed on the other side of the actuator 1. By mounting the fifth connection portion 26 of the weighted shell 23 on the second connection portion 15 on one side of the actuator 1 and mounting the fourth connection portion 25 of the rope-swing shell 22 on the first connection portion 14 on the other side of the actuator 1, the weighted shell 23 and the rope-swing shell 22 are relatively fixed on opposite sides of the actuator 1. Thus, power transmitted by the drive assembly 12 to the transmission shaft 13 drives movement of the rope-swing shell 22. Since the weighted shell 23 is not connected to the transmission shaft 13, the weighted shell 23 remains relatively fixed on one side. Under the influence of a center of gravity of the weighted shell 23, the pet toy 10 presents a motion state of circling on one side while swinging the rope.

Specifically, structural forms of the anti-rotation portion 141 and the anti-rotation mating portion 252 include, but are not limited to, keys and keyways, grooves and protrusions, snap-ring grooves and snap rings, and other cooperating structures configured to restrict circumferential movement. Structural forms of the positioning portion 142 and the positioning mating portion 253 include, but are not limited to, keys and keyways, grooves and protrusions, snap-ring grooves and snap rings, and other cooperating structures configured to restrict axial movement. Structural forms of the snap-fit portion 151 and the snap-fit mating portion 261 include, but are not limited to, hooks and retaining recesses, cantilever hooks and grooves, and other cooperating structures configured for snap connection. Structural forms of the guide portion 152 and the guide mating portion 262 include, but are not limited to, sliders and slide grooves, guide posts and guide sleeves, and other cooperating structures configured to provide guidance.

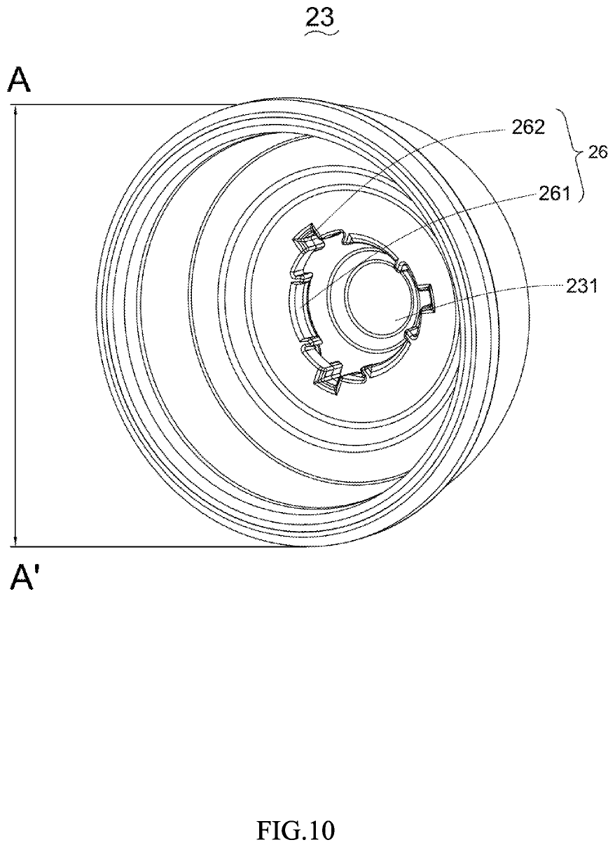

In at least one embodiment, referring to FIGS. 1 and 9, the anti-rotation portion 141 and the anti-rotation mating portion 252 specifically have structures of a keyway and a key, and the positioning portion 142 and the positioning mating portion 253 specifically have structures of an annular groove and an annular protrusion. In at least one embodiment, referring to FIGS. 2 and 10, the snap-fit portion 151 and the snap-fit mating portion 261 specifically have structures of a hook and a retaining recess, and the guide portion 152 and the guide mating portion 262 specifically have structures of a T-shaped slider and a T-shaped slide groove.

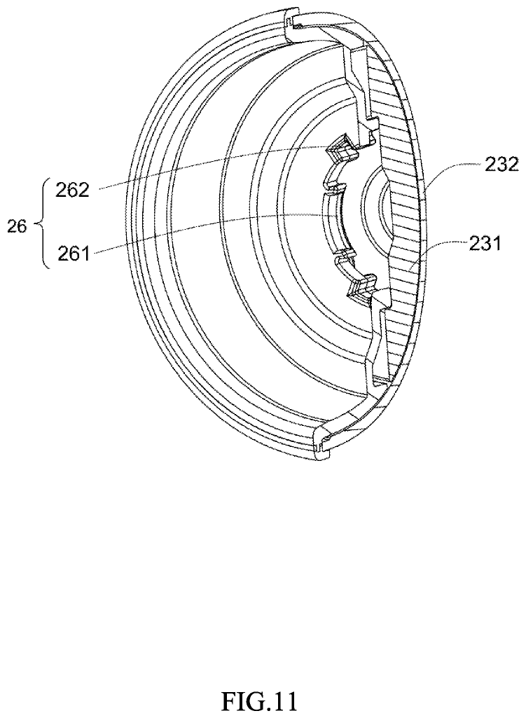

It should be noted that, referring to FIG. 11, through cooperation between the curved surface 232 on an outer side of the weighted shell 23 and the weight block 231 disposed therein, the pet toy 10 provided with the weighted shell 23 has a tumbler characteristic; that is, the curved surface 232 of the weighted shell 23 and the weight block 231 cooperatively form a tumbler shape of the pet toy 10. Under the influence of the weight block 231, the pet toy 10 can automatically return to a stationary state after circling on one side. A length of the second connection portion 15 is less than a length of the transmission shaft 13 extending out of the housing 11, such that the clearance gap 111 is reserved between the second connection portion 15 and the first connection portion 14 on the same side. In response to the fifth connection portion 26 being connected to the second connection portion 15, a space is formed by the weighted shell 23 to accommodate the transmission shaft 13, such that the transmission shaft 13 is separated from the weighted shell 23 by the space; in other words, the transmission shaft 13 rotates but does not drive the weighted shell 23. Referring to FIG. 7, the outer surface of the rope-swing shell 22 is configured to connect to the first rope member 221. The rope-swing shell 22 further includes an inclined channel 223 and a first through hole 222. A diameter of the first through hole 222 is configured to match a diameter of the first rope member 221. The inclined channel 223 is configured to receive the first rope member 221, and the first through hole 222 is configured to retain a knot at one end of the first rope member 221, so that the first rope member 221 is not easily pulled out during pet interaction. Swinging of the first rope member 221 stimulates the pet's senses and arouses the pet's curiosity and interaction. The inclined channel 223 causes the first rope member 221 to extend obliquely, thereby increasing randomness when the rope-swing shell 22 is driven by the transmission shaft 13 and better satisfying a pet's exploratory nature, so as to continuously attract interactive play by the pet. The weighted shell 23 and the rope-swing shell 22 are both hollow inside, so that both define a space for better wrapping the outside of the actuator 1.

Referring to FIGS. 4, 5, and 6, in at least one embodiment of the present application, the housing 11 is provided with the protruding portion 16. The protruding portion 16 protrudes at least partially around an outer circumference of the housing 11. When two shells 2 are respectively connected on opposite sides of the actuator 1, the protruding portion 16 is exposed between the two shells 2, and an edge of the protruding portion 16 is lower than respective edges of the two shells 2.

Specifically, because the protruding portion 16 is not covered by the two shells 2, the protruding portion 16 is exposed on an outer surface of the pet toy 10. Since the edge of the protruding portion 16 is lower than the edges of the two shells 2, the edges of the two shells 2 contact a contact surface first, while the edge of the protruding portion 16 is suspended, so that movement of the shells 2 is not hindered.

Referring to FIGS. 4, 5, and 6, in at least one embodiment of the present application, the pet toy 10 further includes the support member 24. The support member 24 includes a support end 241 and a sixth connection portion 27. The support end 241 and the sixth connection portion 27 are oppositely arranged. An outer surface of the housing 11 is provided with the third connection portion 18, and the sixth connection portion 27 is adapted to the third connection portion 18.

Specifically, the sixth connection portion 27 of the support member 24 is fittingly connected to the third connection portion 18 of the housing 11. Since the support end 241 and the sixth connection portion 27 are oppositely arranged, the support end 241 is located away from the housing 11 and contacts the contact surface. When the pet toy 10 moves, the support end 241 can provide a support point, so that the pet toy 10 changes from an irregular rolling or moving state to a movement state of traveling forward or backward in a single direction, thereby enriching ways of playing with the pet toy 10 and better attracting a pet to interact. It should be understood that the contact surface may be a concrete floor, a wooden floor, or another surface on which the pet toy 10 moves.

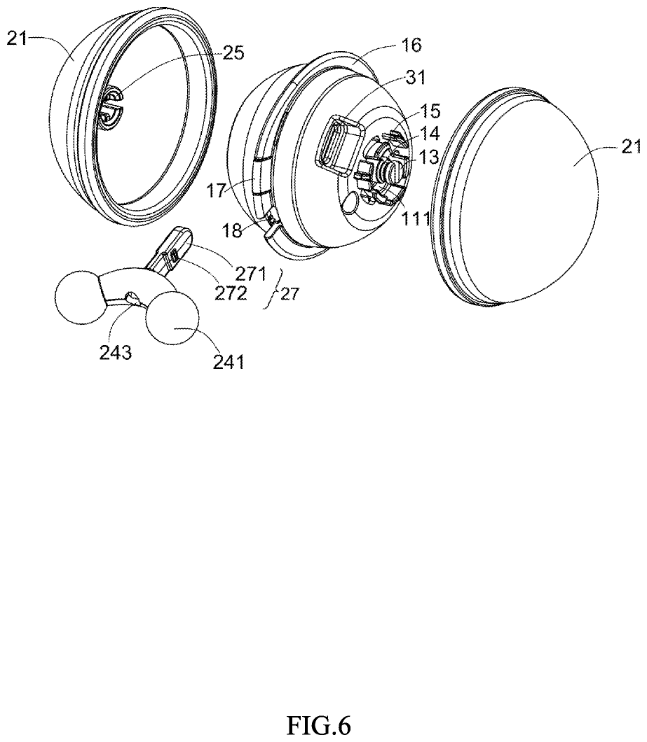

Referring to FIG. 6, in at least one embodiment of the present application, the sixth connection portion 27 includes an insertion mating portion 271 and a limiting mating portion 272. The limiting mating portion 272 is located on an outer surface of the insertion mating portion 271.

Specifically, the third connection portion 18 includes the insertion portion 181 on the outer surface of the housing 11 and the limiting portion 182 located at an edge of the insertion portion 181. When the sixth connection portion 27 is connected to the third connection portion 18, the insertion mating portion 271 is aligned with the insertion portion 181 and approaches the insertion portion 181 for insertion. As the insertion mating portion 271 is inserted in an insertion direction, the limiting mating portion 272 gradually approaches the limiting portion 182, and the limiting portion 182 snaps over the limiting mating portion 272, thereby completing assembly between the sixth connection portion 27 and the third connection portion 18. Through the connection between the support member 24 and the actuator 1, the pet toy 10 gains a support point and can move in a single direction. For example, when two roller shells 21 are relatively fixed on opposite sides of the actuator 1 and the support member 24 is further assembled, the transmission shaft 13 drives the roller shells 21 to move, and the support member 24 functions as a support point with respect to the contact surface, thereby supporting the roller shells 21 to move forward in a single direction. This enriches ways of playing with the pet toy 10 and is also suitable for active pets to chase.

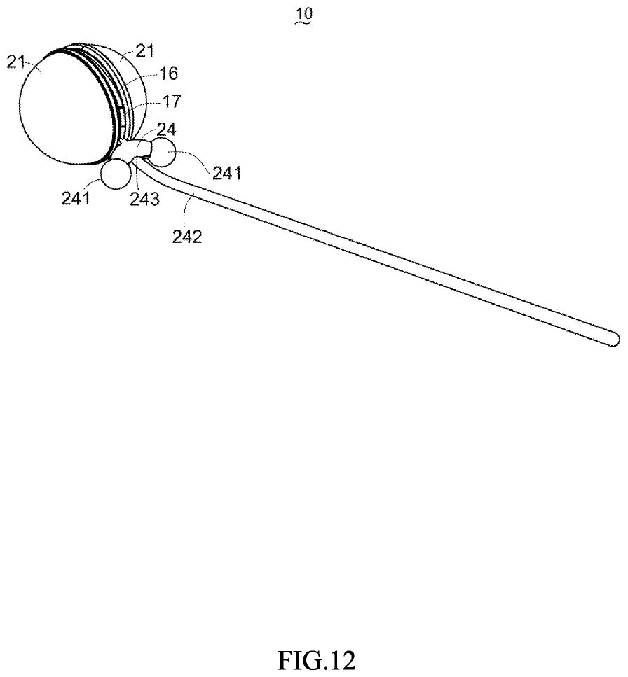

Referring to FIG. 12, in at least one embodiment of the present application, the support member 24 is configured to mount a second rope member 242. The support member 24 includes a second through hole 243, and the support member 24 mounts the second rope member 242 through the second through hole 243.

Specifically, one end of the second rope member 242 may be knotted, or one end of the second rope member 242 may be provided with a stopper. The knot at one end of the second rope member 242 can be retained at the second through hole 243, or the stopper at one end of the second rope member 242 can be retained at the second through hole 243, so that the second rope member 242 is not easily pulled out from the support member 24 during pet interaction. When the support member 24 is provided with the second rope member 242 and the support end 241 contacts and supports the contact surface, the second rope member 242 advances and swings along with the movement of the roller shell 21, like an animal tail, thereby attracting a pet to chase the second rope member 242.

Preferably, there are two support ends 241, and the two support ends 241 are symmetrically distributed. The second rope member 242 is mounted on a symmetry axis of the two support ends 241, so that when the pet toy 10 moves in a single direction, force is balanced and movement of the pet toy 10 is more stable.

It should be understood that, referring to FIGS. 4, 7, 12, and 13, a user may freely combine different shells 2 with the first connection portions 14 and the second connection portion 15 of the actuator 1 through the fourth connection portions 25 of the roller shells 21, the fourth connection portions 25 of the rope-swing shells 22, and the fifth connection portions 26 of the weighted shells 23, thereby forming pet toys 10 of different shapes. The user may further connect the sixth connection portion 27 of the support member 24 to the third connection portion 18 of the actuator 1 to create still more forms of the pet toy 10, thereby enriching ways of playing with the pet toy 10 and continuously attracting a pet's curiosity.

The foregoing descriptions are merely preferred embodiments of the present application and are not intended to limit the scope of protection of the present application. Any equivalent structural modifications made according to the inventive concept of the present application by using the contents of the specification and drawings of the present application, or any direct or indirect application thereof in other related technical fields, shall fall within the scope of protection of the present application.

What is claimed is:

1. An actuator applicable in a pet toy and configured to be connected to a plurality of shells, the actuator comprising:
a housing;
a drive assembly disposed in the housing;
a transmission shaft connected to the drive assembly, opposite ends of the transmission shaft respectively extending out of the housing, each of the opposite ends of the transmission shaft being provided with a first connection portion; and
a second connection portion disposed on one side of the housing,
wherein an axial direction of the transmission shaft coincides with a central axis of the housing, each first connection portion is configured to connect to and drive a corresponding one of the plurality of shells, the second connection portion is disposed on a same side of the housing as one of the first connection portions, the second connection portion is configured to be fixedly connected to one of the plurality of shells, and a clearance gap is defined between the second connection portion and the one of the first connection portions located on the same side.

2. The actuator of claim 1, wherein each first connection portion comprises an anti-rotation portion and a positioning portion, the anti-rotation portion is disposed along the axial direction of the transmission shaft, and the positioning portion is disposed along a circumferential direction of the transmission shaft.

3. The actuator of claim 1, wherein the second connection portion comprises a snap-fit portion and a guide portion, and the snap-fit portion and the guide portion are disposed on an outer surface of the housing and spaced apart around the transmission shaft.

4. The actuator of claim 1, wherein the housing comprises a protruding portion protruding at least partially around an outer circumference of the housing, and the housing further comprises at least one of:
a button adjacent to the protruding portion and protruding along the outer circumference of the housing;
a third connection portion adjacent to the protruding portion and disposed on an outer surface of the housing; and
a light-emitting unit mounted within the housing and arranged to emit light toward the protruding portion.

5. The actuator of claim 4, wherein the third connection portion comprises an insertion portion and a limiting portion, the insertion portion is disposed on the outer surface of the housing, and the limiting portion is located at an edge of the insertion portion.

6. A pet toy, comprising:
a plurality of shells, each of the plurality of shells comprises either a fourth connection portion or a fifth connection portion on an inner surface thereof; and
an actuator connectable to the plurality of shells, wherein a shape of the pet toy corresponds to a shape of the plurality of shells when the actuator is connected to the plurality of shells, the actuator comprising:
a housing;
a drive assembly disposed in the housing;
a transmission shaft connected to the drive assembly, opposite ends of the transmission shaft respectively extending out of the housing, each of the opposite ends of the transmission shaft being provided with a first connection portion; and
a second connection portion disposed on one side of the housing,
wherein an axial direction of the transmission shaft coincides with a central axis of the housing, each first connection portion is configured for a transmission connection with a corresponding one of the plurality of shells, the second connection portion is disposed on a same side of the housing as one of the first connection portions, the second connection portion is configured for a non-transmission connection with one of the plurality of shells, and a clearance gap is defined between the second connection portion and the one of the first connection portions located on the same side;
wherein inner surfaces of two shells of the plurality of shells each comprise a fourth connection portion, each fourth connection portion is adapted to a respective one of the first connection portions, and the actuator is detachably connected to the two shells through the first connection portions at the opposite ends of the transmission shaft and through the fourth connection portion of each of the two shells; or
wherein an inner surface of a first shell of the plurality of shells comprises a fourth connection portion and an inner surface of a second shell of the plurality of shells comprises a fifth connection portion, the fourth connection portion is adapted to one of the first connection portions, the fifth connection portion is adapted to the second connection portion, and the actuator is detachably connected to the first shell and the second shell through the second connection portion cooperating with the fifth connection portion, and through one of the first connection portions on a side opposite to the second connection portion cooperating with the fourth connection portion.

7. The pet toy of claim 6, wherein each first connection portion comprises an anti-rotation portion and a positioning portion, the anti-rotation portion is disposed along the axial direction of the transmission shaft, and the positioning portion is disposed along a circumferential direction of the transmission shaft.

8. The pet toy of claim 6, wherein the second connection portion comprises a snap-fit portion and a guide portion, and the snap-fit portion and the guide portion are disposed on an outer surface of the housing and spaced apart around the transmission shaft.

9. The pet toy of claim 6, wherein the housing comprises a protruding portion protruding at least partially around an outer circumference of the housing, and wherein, when two shells of the plurality of shells are respectively connected to opposite sides of the actuator, the protruding portion is exposed between the two shells, and an edge of the protruding portion is lower than respective edges of the two shells.

10. The pet toy of claim 9, wherein the housing further comprises at least one of:
a button adjacent to the protruding portion and protruding along the outer circumference of the housing;
a third connection portion adjacent to the protruding portion and disposed on an outer surface of the housing; and
a light-emitting unit mounted within the housing and arranged to emit light toward the protruding portion.

11. The pet toy of claim 10, wherein the third connection portion comprises an insertion portion and a limiting portion, the insertion portion is disposed on the outer surface of the housing, and the limiting portion is located at an edge of the insertion portion.

12. The pet toy of claim 6, wherein at least one of the plurality of shells is a roller shell, the roller shell being hollow and hemispherical, an inner surface of the roller shell comprising the fourth connection portion, the fourth connection portion comprising a shaft groove, an anti-rotation mating portion, and a positioning mating portion, wherein the anti-rotation mating portion is distributed axially along an inner wall of the shaft groove, and the positioning mating portion is distributed circumferentially along the inner wall of the shaft groove; or
wherein at least one of the plurality of shells is a rope-swing shell, an outer surface of the rope-swing shell being configured to connect to a first rope member, an inner surface of the rope-swing shell comprising the fourth connection portion, the fourth connection portion comprising a shaft groove, an anti-rotation mating portion, and a positioning mating portion, wherein the anti-rotation mating portion is distributed axially along an inner wall of the shaft groove, and the positioning mating portion is distributed circumferentially along the inner wall of the shaft groove; or
wherein at least one of the plurality of shells is a weighted shell, a weight block being mounted in the weighted shell, the weighted shell comprising a curved surface at a center of an outer surface of the weighted shell, wherein the weight block is disposed adjacent to the curved surface, an inner surface of the weighted shell comprises the fifth connection portion, the fifth connection portion comprises a snap-fit mating portion and a guide mating portion, and the snap-fit mating portion and the guide mating portion are spaced apart around a central axis of the weighted shell.

13. The pet toy of claim 10, further comprising a support member, the support member comprising a support end and a sixth connection portion, wherein the support end and the sixth connection portion are oppositely arranged, and the sixth connection portion is adapted to the third connection portion.

14. The pet toy of claim 13, wherein the sixth connection portion comprises an insertion mating portion and a limiting mating portion, the limiting mating portion is located on an outer surface of the insertion mating portion, and the support member is configured to mount a second rope member and comprises a through hole, the support member being configured to mount the second rope member through the through hole.

15. The pet toy of claim 12, wherein the at least one of the plurality of shells is the roller shell or the rope-swing shell, each first connection portion comprises an anti-rotation portion and a positioning portion, the positioning portion is disposed at an end of the transmission shaft away from the housing, and the positioning mating portion is disposed adjacent to a groove bottom of the shaft groove.

16. The pet toy of claim 15, wherein the anti-rotation portion and the anti-rotation mating portion comprise structures of a keyway and a key, and the positioning portion and the positioning mating portion comprise structures of an annular groove and an annular protrusion.

17. The pet toy of claim 12, wherein the at least one of the plurality of shells is the weighted shell, a length of the second connection portion is less than a length of a portion of the transmission shaft extending out of the housing, and, in response to the fifth connection portion being connected to the second connection portion, a space is formed by the weighted shell to accommodate the transmission shaft, such that the transmission shaft is separated from the weighted shell by the space.

18. The pet toy of claim 12, wherein the at least one of the plurality of shells is the weighted shell, the second connection portion comprises a snap-fit portion and a guide portion, the snap-fit portion and the snap-fit mating portion comprise structures of a hook and a retaining recess, and the guide portion and the guide mating portion comprise structures of a T-shaped slider and a T-shaped slide groove.

19. The pet toy of claim 6, wherein the drive assembly comprises a motor, an input gear, and an output gear, the input gear is mounted on an output end of the motor, the output gear is connected to the transmission shaft, and the input gear meshes with the output gear.

20. The pet toy of claim 6, wherein the housing is configured to receive a power supply, and the housing further comprises at least one of: a charging port on an outer surface of the housing and configured to connect the power supply to the drive assembly; and a sound-generating unit.
